(19) United States
(12) Patent Application Publication
(10) Pub. No.: US 2013/0019960 A1
(43) Pub. Date: Jan. 24, 2013

(54) Reactant Delivery System For ALD/CVD Processes

(71) Applicants: Kenric Choi, San Jose, CA (US); Joseph Yudovsky, Campbell, CA (US); Steven D. Marcus, San Jose, CA (US); Ernesto Ulloa, San Jose, CA (US)

(72) Inventors: Kenric Choi, San Jose, CA (US); Joseph Yudovsky, Campbell, CA (US); Steven D. Marcus, San Jose, CA (US); Ernesto Ulloa, San Jose, CA (US)

(73) Assignee: Applied Materials, Inc., Santa Clara, CA (US)

(21) Appl. No.: 13/554,487

(22) Filed: Jul. 20, 2012

Related U.S. Application Data
(60) Provisional application No. 61/510,677, filed on Jul. 22, 2011.
(60) Provisional application No. 61/526,920, filed on Aug. 24, 2011.

(51) Int. Cl. F16K 49/00; F16K 11/00

(52) U.S. Cl. 137/334; 137/627

(57) ABSTRACT

Provided are apparatus and methods for generating a chemical precursor. The apparatus comprises an inlet line to be connected to an ampoule and an outlet line to be connected to an ampoule. The inlet line having an inlet valve to control the flow of a carrier gas into the ampoule and the outlet line has an outlet valve to control the flow exiting the ampoule. A bypass valve allows carrier gas to bypass the ampoule and purge the outlet valve without flowing gas into the ampoule.

### CROSS-REFERENCE TO RELATED APPLICATIONS

This application claims priority to U.S. Provisional Application No. 61/510,677, filed Jul. 22, 2011, and U.S. Provisional Application No. 61/526,920, filed Aug. 24, 2011.

### BACKGROUND

Embodiments of the invention generally relate to an apparatus and a method for depositing materials. More specifically, embodiments of the invention are directed to a atomic layer deposition chambers with linear reciprocal motion. Additionally, embodiments of the invention an apply to rotational reciprocal motion and stationary deposition chambers.

Integrated circuits have evolved into complex devices that include millions of transistors, capacitors, and resistors on a single chip. The evolution of chip design continually requires faster circuitry and greater circuit density demanding increasingly precise fabrication processes. The precision processing of substrates requires precise control of temperature, rate, and pressure in the delivery of fluids used during processing.

Chemical vapor deposition (CVD) and atomic layer deposition (ALD) are vapor deposition processes are used to form or deposit various materials on a substrate. In general, CVD and ALD processes involve the delivery of gaseous reactants to the substrate surface where a chemical reaction takes place under temperature and pressure conditions favorable to the thermodynamics of the reaction. The type and composition of the layers that may be formed using a CVD process or an ALD process are limited by the ability to deliver a chemical reactant or precursor to the substrate surface. Various liquid precursors have been successfully used during CVD and ALD applications by delivering the liquid precursors within a carrier gas.

A carrier gas is, in some cases, passed through a heated vessel or canister, such as an ampoule or bubbler, which contains a volatile liquid precursor under conditions conducive to vaporize the precursor. For high vapor pressure liquid precursors, the carrier gas can pass through an ampoule or bubbler that is held at a temperature below room temperature. In other cases, a carrier gas is passed through a heated vessel containing a solid precursor under conditions conducive to sublime the solid precursor. The sublimation process is typically performed in a vessel loaded or filled with a solid precursor, and the vessel walls are heated to sublime the solid precursor material while producing a gaseous precursor. In either case, the carrier gas combines with the vaporized precursor to form a process gas which is drawn from the vessel via dedicated conduits or gas lines to a reaction chamber.

A vapor deposition process that utilizes a solid precursor may suffer several problems. While a solid precursor should be provided enough heated to be sublimed into a gaseous state, the solid precursor may decompose or agglomerate if exposed to too much heat. Metal-organic solid precursors, which are usually very expensive, are especially susceptible to thermal decomposition and generally need to be maintained within narrow temperature and pressure ranges during a sublimation process. Once decomposed, solid precursors may contaminate the remaining precursor in the vessel, the delivery system of conduits and valves, the processing chamber, as well as the substrate. Furthermore, overheating a solid precursor may provide too high of a precursor concentration within the process gas, which may lead to wasted precursor that is never used or condensation of the precursor within the delivery lines or on the substrate.

Alternatively, the solid precursor may not sublime if exposed to too little heat. As the carrier gas is flowed through the vessel and impacts the solid precursor, particulates from the solid precursor may become entrained in the carrier gas and transferred into the process chamber. These undesired solid or liquid particulates may become a source of contamination for the delivery system, processing chamber, or substrate. The problem of particulate contamination has been addressed in the art by including a liquid carrier material mixed with a solid precursor. However, the mixture of the liquid carrier material and the solid precursor may only be conducive within limited temperature and pressure ranges since the liquid carrier material may be evaporated and become a contaminant within the delivery system, processing chamber, or on the substrate.

Therefore, there is an on-going need for improved apparatus and methods for forming a process gas within an ampoule or bubbler and providing the process gas to a processing chamber.

### SUMMARY

Some embodiments of the invention are directed to apparatus for generating a chemical precursor. The apparatus comprises an inlet line, an outlet line and a purge line. The inlet line is in fluid communication with a carrier gas and has an ampoule inlet valve to control the flow of the carrier gas into an ampoule. The outlet line has an outlet valve to control the flow of precursor vapor and carrier gas exiting an ampoule. A bypass valve is downstream of the ampoule outlet valve. The bypass valve allows the carrier gas to flow from the inlet line to purge the outlet line without flowing carrier gas into an ampoule. The purge line comprises a second outlet valve in fluid communication with the purge line to flow a purge gas to a processing chamber. The apparatus further comprises a third outlet valve to flow the chemical precursor from an ampoule to a foreline bypassing the processing chamber.

In some embodiments, the bypass valve is upstream of the ampoule inlet valve. In one or more embodiments, the bypass valve is downstream of the ampoule inlet valve.

In some embodiments, the second outlet valve comprises a first input in fluid communication with the purge line and second input in fluid communication with the outlet line. In one or more embodiments, the second valve is a three-way valve which can pass only the flow from the outlet line or only the flow from purge line, or a mixture of flows from the purge line and the outlet line to the processing chamber.

Some embodiments further comprise an ampoule having a top, bottom and a body defining an interior volume, the ampoule comprising an inlet conduit and an outlet conduit. In one or more embodiments, the ampoule further comprises at least one additional conduit with an isolation valve, the additional conduit in fluid communication with an interior of the ampoule. In some embodiments, the ampoule contains one or more of a solid precursor, a liquid precursor and a gaseous precursor.

In some embodiments, the processing chamber is a chemical vapor deposition chamber or an atomic layer deposition chamber.

In some embodiments, one or more of the inlet line and the purge line comprises a heater. One or more embodiments, further comprise a monometer upstream of each heater.

In some embodiments, the inlet line comprises an exhaust line upstream of the ampoule. In one or more embodiments, the exhaust line comprises a back pressure controller upstream of and in fluid communication with an isolation valve. In some embodiments, the exhaust line comprises a manual orifice upstream of and in fluid communication with an isolation valve.

Embodiments of the invention are directed to an apparatus for generating a chemical precursor. The apparatus comprises an inlet line, an outlet line, a purge line and a bypass line. The inlet line comprises a first heater and a first valve. The inlet line configured to be connected to an inlet conduit of an ampoule. The outlet line comprises a first three-way valve and a second three-way valve. The first three-way valve has one inlet and two outlets with one of the two outlets connecting to an exhaust and the other outlet in fluid communication with the second three-way valve. The second three-way valve has two inlets and one outlet, the first inlet in fluid communication with the outlet of the first three-way valve and the second inlet in fluid communication with a purge line. The outlet line is configured to be connected to an outlet conduit of the ampoule upstream of the first three-way valve. The purge line comprises a second heater and a second valve and is in fluid communication with one inlet of the second three-way valve. The bypass line comprises a bypass valve and is in fluid communication with the inlet line downstream of the first heater and the first valve and the outlet line upstream of the first three-way valve. The bypass line is configured to allow a flow of gas to pass from the inlet line to the outlet line without passing through the ampoule.

In some embodiments, the first heater is upstream of and in fluid communication with the first valve. In one or more embodiments, the second heater is upstream of and in fluid communication with the second valve. In some embodiments, the first heater is downstream of and in fluid communication with the first valve.

In some embodiments, the apparatus further comprises an exhaust line upstream of the first heater and in fluid communication with the inlet line. In some embodiments, the exhaust line comprises a back pressure controller upstream of and in fluid communication with an isolation valve. In one or more embodiments, the exhaust line comprises a manual orifice upstream of and in fluid communication with an isolation valve.

In some embodiments, the apparatus further comprises an ampoule having a top, bottom and a body defining an interior volume, the ampoule comprising an inlet conduit and an outlet conduit. In some embodiments, the ampoule further comprises at least one of additional conduit with an isolation valve, the additional conduit in fluid communication with an interior of the ampoule. In one or more embodiments, the ampoule contains a solid precursor.

In some embodiments, the apparatus further comprises a first monometer upstream of the first heater and the first valve. In some embodiments, the apparatus further comprises a second monometer upstream of the second heater and the second valve.

In some embodiments, the outlet of the second three-way valve is in fluid communication with a processing chamber. In some embodiments, the processing chamber is a chemical vapor deposition chamber or an atomic layer deposition chamber.

Additional embodiments of the invention are directed to apparatus for generating a chemical precursor. The apparatus comprises an inlet line, an outlet line, a purge line and a bypass line. The inlet line comprises a first heater upstream of and in fluid communication with a first valve. The inlet line is configured to be connected to an inlet conduit of an ampoule. The outlet line comprises a first three-way valve and a second three-way valve. The first three-way valve has one inlet and two outlets with one of the two outlets connecting to an exhaust and the other outlet in fluid communication with the second three-way valve. The second three-way valve has two inlets and one outlet, the first inlet in fluid communication with the outlet of the first three-way valve and the second inlet in fluid communication with a purge line. The outlet line is configured to be connected to an outlet conduit of the ampoule upstream of the first three-way valve. The purge line comprises a second heater and a second valve. The purge line is in fluid communication with one inlet of the second three-way valve. The bypass line comprises a bypass valve and is in fluid communication with the inlet line downstream of the first heater and the first valve. The outlet line is upstream of the first three-way valve. The bypass line is configured to allow a flow of gas to pass from the inlet line to the outlet line without passing through the ampoule.

Further embodiments of the invention are directed to apparatus for generating a chemical precursor. The apparatus comprises an inlet line, an outlet line, a bypass line, a purge line and an exhaust line. The inlet line comprises a first valve and is configured to be connected to an inlet conduit of an ampoule downstream of the first valve. The outlet line is configured to be connected to an outlet conduit of the ampoule and is in fluid communication with a three-way valve. The bypass line comprises a bypass valve and is in fluid communication with the inlet line downstream of the first valve and the outlet line. The bypass line is configured to allow a flow of gas to pass from the inlet line to the outlet line without passing through the ampoule. The purge line comprises a heater and is in fluid communication with the three-way valve downstream of the heater. The exhaust line is in fluid communication with the inlet line upstream of the first valve and the outlet line upstream of the three-way valve. The exhaust line comprises at least two valves.

Some embodiments of the apparatus further comprise at least one monometer connected to one or more of the purge line and the inlet line. In some embodiments, the ampoule comprises a liquid vapor source. In one or more embodiments, the three-way valve is in fluid communication with a processing chamber. In one or more embodiments, the processing chamber is a chemical vapor deposition chamber of an atomic layer deposition chamber.

### BRIEF DESCRIPTION OF THE DRAWINGS

So that the manner in which the above recited features of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic of a reagent delivery system in accordance with one or more embodiments of the invention;

FIG. 2 shows a schematic of a reagent delivery system in accordance with one or more embodiments of the invention;

FIG. 3 shows a schematic of a reagent delivery system in accordance with one or more embodiments of the invention;

FIG. 4 shows a schematic of a reagent delivery system in accordance with one or more embodiments of the invention; and

FIG. 5 shows a schematic of a reagent delivery system in accordance with one or more embodiments of the invention.

### DETAILED DESCRIPTION

Embodiments of the invention are directed to apparatus and methods to improve precursor delivery systems by stabilizing the pressure of the carrier/push gas (e.g., nitrogen or argon) before flowing it into the ampoule. Stabilizing the pressure may minimize and potentially eliminate entrainment of precursor, and can provide a more consistent dose to the process chamber. This may also remove the need to dump precursor which will help reduce the cost of ownership. Embodiments of the invention can be used with solid precursors or liquids that are either used in a bubbler or vapor draw mode. In liquid delivery systems using higher vapor pressure precursors (e.g., SiCl₄, TiCl₄, TMA), stabilization of pressure in the ampoule may be important to ensure consistent repeatable dosing.

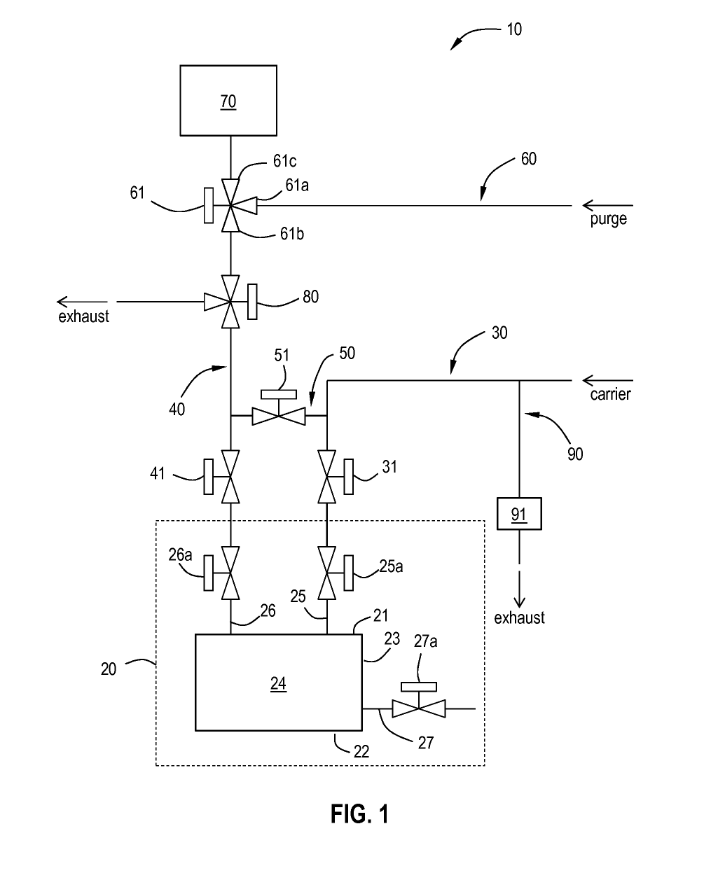

FIG. 1 shows a simplified schematic of a typical process gas delivery system 102 which is suitable for producing a process gas containing a chemical precursor and generally includes process chamber 106 and a carrier gas source 105 coupled to gas panel 104, the components of the latter being controlled by a controller 150. Gas panel 104 generally controls the rate and pressure at which various process and carrier gases are delivered to process chamber 106. Process chamber 106 may be a chamber to conduct vapor deposition processes or thermal processes containing a vaporized chemical precursor in liquid, gaseous or plasma state. Process chamber 106 is generally a chemical vapor deposition (CVD) chamber, an atomic layer deposition (ALD) chamber, or a derivative thereof.

FIG. 1 shows a broad aspect an apparatus 10 for generating a chemical precursor. The apparatus shows an ampoule 20 in dotted lines. In some embodiments, the ampoule 20 is intended to be used with the apparatus 10, but is not a part of the apparatus 10. The ampoule 20 has a top 21, bottom 22 and a body 23 defining an interior volume 23. The ampoule 20 includes an inlet 25 and an outlet 26 and may also include at least one additional conduit 27 in fluid communication with the interior volume 24 of the ampoule. The additional conduit 27 may include an isolation valve 27a and can be used to pressurize or depressurize the ampoule 20. The inlet 25 may include an inlet isolation valve 25a to isolate the inlet from the ambient environment when the ampoule is not connected. The outlet 26 may include an outlet isolation valve 26a to isolate the outlet from the ambient environment when the ampoule is not connected. After connecting the ampoule 20 to the generating apparatus 10, the inlet isolation valve 25a and the outlet isolation valve 26a can be opened to allow fluid communication with the interior volume 24 of the ampoule 20.

The ampoule can contain any type of precursor suitable for use in the intended deposition process. In some embodiments, the ampoule 20 contains one or more of a solid precursor and a liquid precursor. The solid precursor or liquid precursor can be added to the ampoule by separating the top 21 from the body 23, or through the additional conduit 27. In one or more embodiments, the ampoule 20 comprises a solid precursor.

The apparatus 10 includes an inlet line 30 in fluid communication with a carrier gas or a carrier gas source. The inlet line 30 has an ampoule inlet valve 31 to control the flow of the carrier gas into an ampoule 20, when an ampoule 20 is present. The apparatus 10 also includes an outlet line 40 comprising an outlet valve 41 to control the flow of precursor vapor and carrier gas exiting the ampoule 20, when the ampoule 20 is present.

A bypass line 50 connects the inlet line 30 and the outlet line 40. The bypass line 50 comprises a bypass valve 51 downstream of the ampoule outlet valve 26a, when an ampoule 20 is present. The bypass valve 51 allows carrier gas to flow from the inlet line 30 to purge the outlet line 40 without flowing carrier gas into the ampoule 20. For example, when there is no ampoule 20 present, the bypass valve 51 can be open to allow the flow of carrier gas. The bypass line 50 and bypass valve 51 of some embodiments, is upstream of the ampoule inlet valve 31. In one or more embodiments, the bypass line 50 connects to the inlet line 30 downstream of the ampoule inlet valve 31. In some embodiments, the bypass line 50 and bypass valve 51 are in communication with the outlet line 40 downstream of the ampoule outlet valve 41. In one or more embodiments, the bypass line 50 connects to the outlet line 40 upstream of the ampoule outlet valve 41. In some embodiments, the bypass line 50 connects to and is in fluid communication with the inlet line 30 upstream of the ampoule inlet valve 31 and connects to and is in fluid communication with the outlet line 40 downstream of the ampoule outlet valve 41. In one or more embodiments, the bypass line 50 connects to and is in fluid communication with the inlet line 30 downstream of the ampoule inlet valve 31 and connects to and is in fluid communication with the outlet line 40 upstream of the ampoule outlet valve 41.

A purge line 60 is in fluid communication with a purge gas or a purge gas source. The purge line 60 comprises a second outlet valve 61 in fluid communication with the purge line 60 to allow a flow of a purge gas to the processing chamber 70. In some embodiments, the second outlet valve 61 comprises a first input 61a in fluid communication with the purge line 60 and a second input 61b in fluid communication with the outlet line 40. The second outlet valve 61 may then also include a first outlet 61c to direct the flow toward the processing chamber 70. In some embodiments, the second valve 61 is a three-way valve or proportioning valve which can pass the flow from only one of the outlet line 40 and the purge line 60 to the processing chamber 70 or can mix the flow from the outlet line 40 and the purge line 60. The mixed flow can range from entirely outlet line 40 to entirely purge line 60 and all states in-between.

A third outlet valve 80 in fluid communication with the outlet line 40 and allows the flow of chemical precursor and/or carrier gas from the ampoule 20 to be directed to an exhaust line (foreline) bypassing the processing chamber 70. In some embodiments, the third outlet valve 80 is downstream of the bypass line 50 in fluid communication with the outlet line 40. This configuration allows the gas to be directed to the foreline when there is no ampoule 20 present. In one or more embodiments, the third outlet valve 80 is upstream of the bypass line 50 and in fluid communication with the outlet line 40.

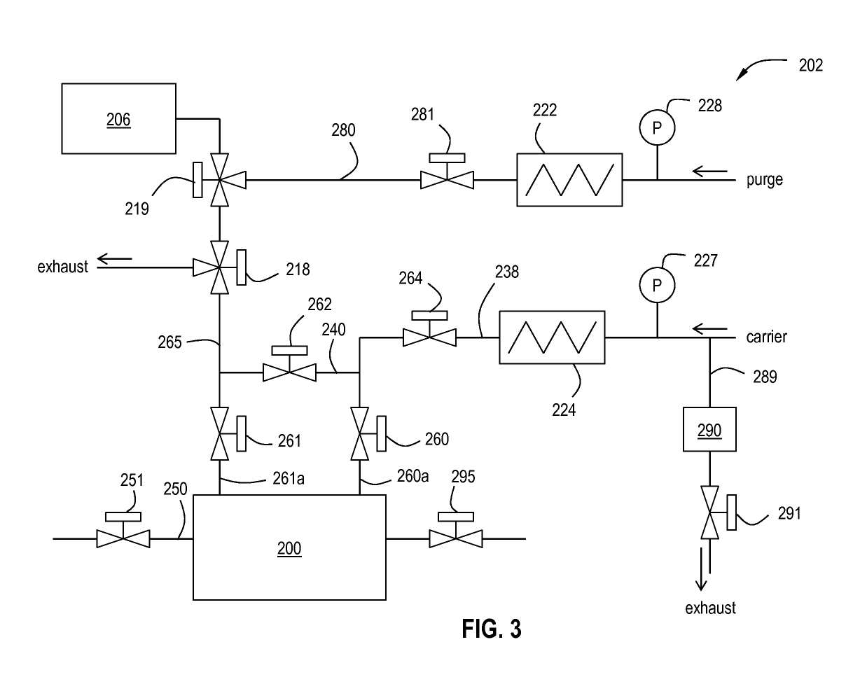

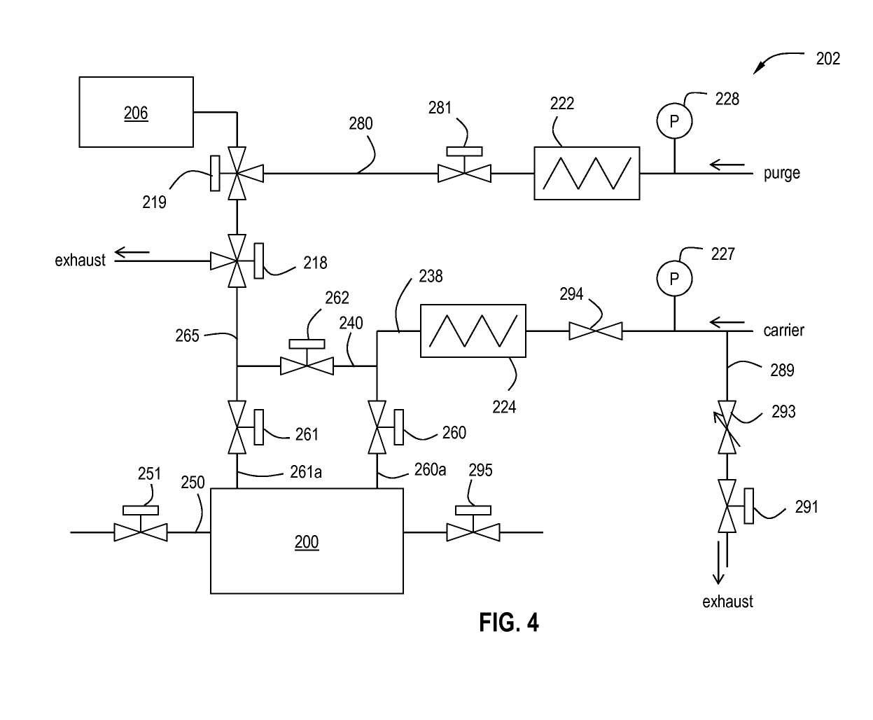

In some embodiments, inlet line 30 comprises an exhaust line 90 upstream of the ampoule 20, when the ampoule 20 is present. The exhaust line comprises an exhaust device 91 in fluid communication with the exhaust line. The exhaust device 91 of some embodiments is a back pressure controller positioned upstream of and in fluid communication with an isolation valve (see FIG. 3). In one or more embodiments, the exhaust device 91 comprises a manual orifice upstream of and in fluid communication with an isolation valve (see FIG. 4).

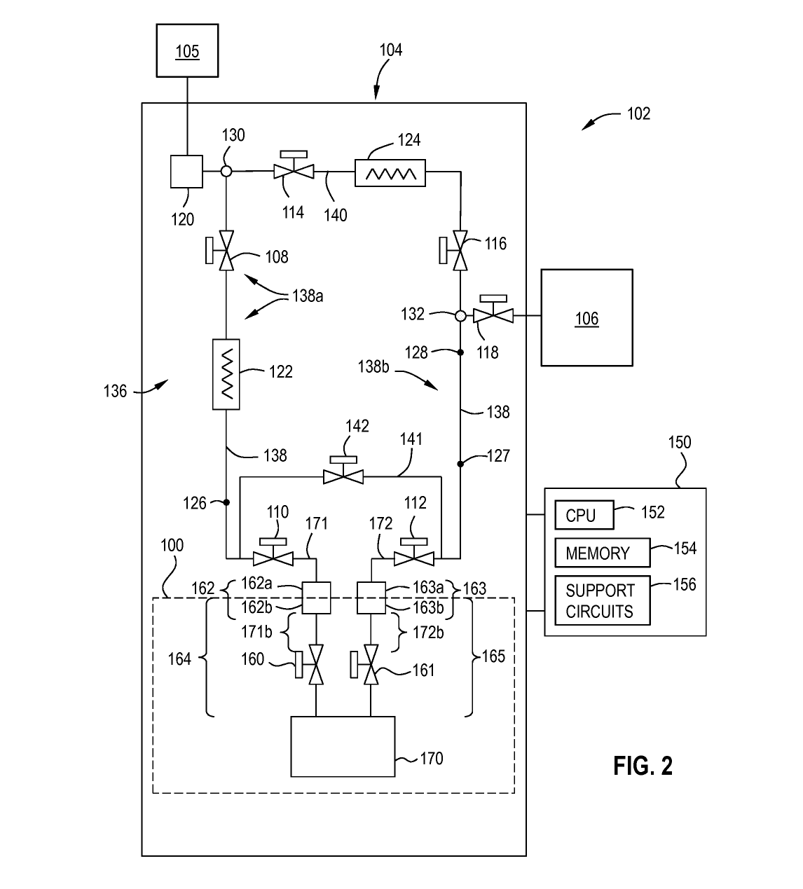

In the configuration illustrated in FIG. 2, controller 150 includes central processing unit (CPU) 152, memory 154, and support circuits 156. Central processing unit 152 may be one of any form of computer processor that can be used in an industrial setting for controlling various chambers and sub-processors. Memory 154 is coupled to CPU 152 and may be one or more of readily available memory such as random access memory (RAM), read only memory (ROM), flash memory, compact disc, floppy disk, hard disk, or any other form of local or remote digital storage. Support circuits 156 are coupled to CPU 152 for supporting CPU 152 in a conventional manner. These circuits include cache, power supplies, clock circuits, input/output circuitry, subsystems, and the like.

Fluid delivery circuit 136 is generally intended to fluidly couple carrier gas source 105, ampoule 100, and process chamber 106 as necessary for operation of process chamber 106. Carrier gas source 105 may be a local vessel, remote vessel or a centralized facility source that supplies the carrier gas throughout the facility (e.g., in-house gas supply). Carrier gas source 105 typically supplies a carrier gas such as nitrogen, hydrogen, argon, helium, or combinations thereof. Additional purge fluid sources (not shown) may also be fluidly coupled to fluid delivery circuit 136 when the use of specialized purge fluids, such as a purge liquid, is required. Fluid delivery circuit 136 typically includes a flow controller 120 disposed between carrier gas source 105 and junction 130 and is adapted to modulate the flow rate of carrier gas or other fluids through fluid delivery circuit 136. Flow controller 120 may be a proportional valve, a modulating valve, a needle valve, a regulator, a mass flow controller (MFC) or the like. Junction 130 separates fluid delivery circuit 136 into gas generation line 138 and, bypass line 140. Junction 132 rejoins gas generation line 138 and bypass line 140 before connecting to process chamber 106.

Gas generation line 138 includes ampoule inlet leg 138a, ampoule outlet leg 138b, valves 108, 110, 112, sensors 126, 128, disconnect fittings 162, 163, and heater 122. Ampoule inlet leg 138a fluidly couples the inlet of ampoule 100 to carrier gas source 105 and to bypass line 140 or. Ampoule outlet leg 138b fluidly couples the outlet of ampoule assembly 100 to process chamber 106 and to bypass line 140. Valves 108, 110 and 112 are typically remotely controllable shut-off valves that serve to divert the flow of fluids within fluid delivery circuit 136 and/or are used to selectively isolate the various components within fluid delivery circuit 136 to facilitate removal, replacement and/or service of an isolated component, including sensors 126, 128, heater 122, and ampoule assembly 100. Valves 108, 110, 112, as well as valves 114, 116, 118 (described below in conjunction with bypass line 140) are generally pneumatically or electronically controlled and the internal wetted surfaces thereof are fabricated from materials compatible with the process and other fluids handled by fluid delivery circuit 136. Typically, valves 108, 110, 112, 114, 116, and 118 are actuated in response to a signal from a controller 150 to coordinate the delivery of gases through fluid delivery circuit 136. Sensors 126, 128 are generally adapted to detect the temperature of a process, carrier, and/or purge fluid flowing through gas generation line 138, such as a thermocouple disposed against a conduit of gas generation line 138. Flow sensor 127 on the outlet of the ampoule is used to determine the flux delivered to the chamber.

Bypass line 140 generally includes valves 114, 116 and heater 124 and serves to fluidly couple process chamber 106 and carrier gas source 105 without the use of gas generation line 138 or ampoule assembly 100. Valve 118 is generally coupled between junction 132 and process chamber 106 and may be used to isolate process chamber 106 from fluid delivery circuit 136. Heaters 122, 124 are resistive heating elements or other heat sources adapted to heat a flow of fluid, such as a carrier gas, flowing through gas generation line 138 and bypass line 140, respectively.

Ampoule assembly 100 generally contains an ampoule, or body 170, an inlet line 164, an outlet line 165, disconnect fittings 162b, 163b, and manual shut-off valves, manual valves 160, 161, disposed in inlet line 164, 165, respectively. Dead leg conduit segment 171b is disposed in inlet line 164 between manual valve 160 and disconnect fitting 162 and dead leg conduit segment 172b is disposed in outlet line 165 between manual valve 161 and disconnect fitting 163. Ampoule assembly 100 may also be referred to as a bubbler, a canister, and other terms known in the art to describe containers designed and used to store, transport and distribute chemical precursors. Inlet line 164 is coupled to ampoule inlet leg 138a at disconnect fitting 162 and outlet line 165 is coupled to ampoule outlet leg 138b at disconnect fitting 163. Disconnect fitting 162, 163 are typically adapted to facilitate removal and replacement of ampoule assembly 100 in gas panel 104 while leaving all other components of gas panel 104 in place, such as gas generation line 138 and its constituent parts. To this end, disconnect fittings 162, 163 typically include mating disconnect fittings 162a, 162b and 163a, 163b respectively, wherein disconnect fittings 162b, 163b are inherent to ampoule assembly 100 and corresponding disconnect fittings 162a, 163a are contained in fluid delivery circuit 136. Depending on the application, disconnect fittings 162a, 162b and 163a, 163b may be quick disconnect type fittings, re-sealable vacuum-tight fittings, such as VCR fittings, or other suitable disconnect fittings.

Ampoule assembly 100 may have a variety of sizes and geometries. Ampoule assembly 100 may have a volume capacitance of a chemical precursor within a range from about 0.5 L to about 10 L and more typically from about 1.2 L to about 4 L. In one example, ampoule assembly 100 has a volume capacitance of a chemical precursor of about 2.5 L. Chemical precursors that may be within ampoule assembly 100 include liquid, solid and gaseous precursors, preferably in liquid or fluid-like states at predetermined temperatures and/or pressures. For example, a chemical precursor may exist in the solid state at room temperature, but melts to the liquid state upon being heated to a predetermined temperature within the ampoule. In another example, the majority of a chemical precursor may remain in the solid state in the ampoule, but is heated to an elevated temperature during processing such that a small amount of the solid precursor sublimates directly into vapor. In another example, a chemical precursor may exist in the gaseous state at ambient pressure, but condenses to the liquid state upon being pressurized to a predetermined pressure within the ampoule.

During processing, a carrier gas flows from carrier gas source 105 through fluid delivery circuit 136 to ampoule assembly 100. The carrier gas may be heated by heater 122, ampoule assembly 100 may be heated to a desired temperature, or in some applications, both the carrier gas and ampoule assembly 100 may be heated. During processing, valves 114 and 116 are closed, directing all carrier gas flow to process chamber 106 via gas generation line 138 and ampoule assembly 100.

During an initial pump-purge procedure performed prior to removing and replacing ampoule assembly 100, manual valves 160, 161 or pneumatic valves 110, 112 are closed. This isolates body 170 from gas generation line 138. During a pump-down segment of a pump-purge procedure, carrier gas source 105 is also isolated from fluid delivery circuit 136 by a shut-off valve (not shown) located between carrier gas source 105 and fluid delivery circuit 136. The vacuum source for process chamber 106 is typically used to pump down fluid delivery circuit 136 and dead leg conduit segments 171b, 172b of ampoule assembly 100. Alternatively, a dedicated vacuum source may be used, such as a vacuum pump fluidly coupled to fluid delivery circuit 136. In either case, all components of fluid delivery circuit 136 that are not isolated from the vacuum source are pumped down to a desired vacuum level, e.g. rough, medium, or high vacuum, by opening the requisite valves in gas panel 104. For example, when the vacuum source of process chamber 106 is used for pumping down fluid delivery circuit 136, valve 118 is opened to fluidly couple process chamber 106 to fluid delivery circuit 136, valves 114 and 116 are opened so that bypass line 140 fluidly couples ampoule inlet leg 138a to vacuum, and valves 110 and 112 are opened to fluidly couple conduit segments 171, 172 and dead leg conduit segments 171b, 172b to vacuum. The desired level of vacuum targeted during the pump-down segment depends on each particular CVD or ALD application and is a function of factors such as the vapor pressure of precursors, other residues being removed, and fluid delivery line length. In one embodiment, personnel may enter gas panel 104 despite the presence of unpurged fluid delivery lines in order to close manual valves 160, 161 of ampoule assembly 100.

For a purge segment of a pump-purge procedure, a purge fluid source, such as carrier gas source 105, is fluidly coupled to fluid delivery circuit 136 and the desired purge fluid is introduced therein. The desired purge fluid may be a gas, such as an inert gas or other carrier gas, or a liquid, including solvents such as tetrahydrofuran (THF) or triglyme or octane. Composition of the purge fluid depends on the physical state and chemical make-up of the chemical residues to be purged, solid particles and low vapor pressure liquids sometimes requiring one or more liquid solvent purges. Further, the purge fluid may also be heated during the purge segment to aid in the removal of unwanted chemical residue, either prior to be introduced into fluid delivery circuit 136 or by heaters 122, 124. The vacuum source, such as process chamber 106 in one example, may be isolated from fluid delivery circuit 136 during the purge segment or it may be fluidly coupled thereto in order to continuously remove purge fluid throughout the purge segment. The active flow of purge fluid may occur principally along bypass line 140 during a purge procedure. The only active flow of purge fluid into ampoule inlet leg 138a and ampoule outlet leg 138b occurs when these two sections of fluid delivery circuit are back-filled with purge fluid at the beginning of a purge segment. Hence, ampoule inlet leg 138a and ampoule outlet leg 138b act as extensive dead legs of significant length and potentially include numerous flow-restricting elbows. Further, the regions of fluid delivery circuit 136 that will be exposed to atmosphere during ampoule replacement, i.e. conduit segments 171, 172, and dead leg conduit segments 171b, 172b, may likely to be contaminated and may be thoroughly purge in preparation thereof. However, conduit segments 171, 172, and dead leg conduit segments 171b, 172b are located at the distal ends of the above-described dead legs and are difficult regions of fluid delivery circuit 136 to effectively purge.

During removal, valves 110 and 112 are closed to fluidly isolate conduit segments 171, 172 from fluid delivery circuit 136, and disconnect fittings 162, 163 are separated to allow removal of ampoule assembly 100, wherein mating disconnect fittings 162b, 163b inherent to ampoule assembly 100 and are removed therewith. As noted above, it is known in the art that ampoule shut-off valves, i.e. manual valves 160, 161, may not always be completely leak-tight after prolonged exposure to the precursor chemicals contained in ampoule assembly 100. Because a single point of isolation is used for ampoule assembly 100 at inlet line 164 and outlet line 165, i.e. manual valves 160, 161, respectively, there is the potential of leakage into or out of ampoule assembly 100 during the removal of a depleted ampoule from gas panel 104. A freshly-charged ampoule is reconnected to fluid delivery circuit 136 at disconnect fittings 162, 163.

After installation of a new ampoule assembly 100, any fluid delivery connection points or other seals that were broken during ampoule removal/replacement are leak-checked, in this example disconnect fittings 162, 163. Leak checking ensures that contaminants are not drawn into fluid delivery circuit 136 and that toxic chemical precursors do not leak out of ampoule assembly 100 during processing. If either of disconnect fittings 162, 163 are not vacuum-tight, only a single point of isolation is present between the chemical contents of ampoule assembly 100 and any contaminants that may have leaked into dead leg conduit segments 171b, 172b.

FIG. 3 shows gas delivery system 202 in accordance with one or more embodiments of the invention. Ampoule 200 has a series of valves 260, 261 on the top of the ampoule 200 or on the sides of the ampoule 200. The valves 260, 261 facilitate the movement of precursor vapor out of the ampoule 200 and into the process reactor. Inlet valve 260 controls the inert Carrier/Push gas flow into the ampoule 200 and outlet valve 261 controls the precursor vapor. The valves described can be any suitable valve mechanism, including but not limited to, pneumatic valves and manual valves. It will be understood by those skilled in the art that a valve described as, e.g., a pneumatic valve, can be replaced with other types of valves, and that description of specific valve mechanisms should not be taken as limiting the scope of the invention.

Upstream of the inlet valve 260 is a bypass line 240. The bypass line 240 connects upstream of the inlet valve 260 and downstream of outlet valve 261 of the ampoule 200. Along the bypass line 240 is a bypass valve 262 that controls the flow of carrier gas and allows the carrier gas to bypass the ampoule 200. The bypass valve 262 allows the user to purge the outlet valve 261 without flowing into the ampoule 200. The bypass valve 262 helps ensure that the outlet line 265 downstream of the ampoule 200 are cleared before the ampoule 200 is removed. Immediately upstream of the inlet valve 260 and downstream of outlet valve 261 are manual valves (not shown). These manual valves provide a secondary means of isolating the ampoule 200. Stated differently, the ampoule 200 may include inlet conduit 260a and outlet conduit 261a with a bypass line 240 includes a remotely controlled bypass valve 262 fluidly connecting the inlet conduit 260a and outlet conduit 261a.

Downstream of the outlet valve 261, bypass line 240 and the manual valve (not shown) is a three-way valve 218, having a single inlet and two outlets. One of the outlets of three-way valve 218 directs flow toward the process chamber 206 and the other outlet directs flow to the foreline, bypassing the chamber 206.

The embodiment shown in FIG. 3 includes a second three-way valve 219 between three-way valve 218 and the chamber 206. The second three-way valve 219 is connected to a purge line 280 that can be used to flow a purge gas (e.g., nitrogen). The purge gas can be used as a dilution gas and Venturi to quickly draw the vapor out of the ampoule 200. Upstream of the three-way valve 219 on the purge line 280 is valve 281 which is used to isolate the purge 280 line so that the ampoule 200 can be used in a pure vapor draw mode. Upstream of valve 260 on the inlet line 238 is valve 264 which is used to pump and purge the lines around the ampoule 200. Upstream of either or both of valve 281 on the purge line 280 and valve 264 on inlet line 238 are gas heaters 222, 224 that are used to elevate the temperature of the gas flowing through the respective line so that it does not cause the precursor to condense in the lines.

Further upstream of the first heater 224 on the inlet line 238 is an exhaust line 289 comprising a back pressure controller 290. The purpose of the back pressure controller 290 is to allow the gas in the inlet line 238 to stabilize in pressure before flowing into the ampoule 200. This may help to prevent a rapid increase in pressure into the ampoule 200 which can cause damage or result in unpredictable precursor concentrations and may help to prevent entrainment of the precursor. Without being bound by any particular theory of operation, when there is setpoint for flow, a mass flow controller (not shown) and isolation valve 291 downstream of the MFC opens, a slight burst in pressure enters the ampoule 200. To mitigate this burst, gas flows into the back pressure regulator 290 and subsequently into the foreline. The back pressure regulator 290 is used to set the pressure of the gas so that it is maintained at a specific pressure.

The embodiment of FIG. 3 can be used in a closed-loop configuration with the inclusion of manometers 227, 228. A closed loop configuration will allow the pressure of the carrier gas in the inlet line 238 to match that of the ampoule 200 during the introduction of the carrier gas into the ampoule 200. After processing, any fluctuations of the ampoule will be captured and the back pressure will be set accordingly. Diverting carrier gas also removes the need for dumping precursor to stabilize flow.

A third port with an isolation valve 295 on the ampoule 200 lid or side walls can be used to depressurize the ampoule 200. The purpose of this port allows the user to relieve the pressure in the ampoule 200 to the operating set-point. This feature may help mitigate any entrainment of the precursor in the delivery line to the chamber and eliminate particles from the burping process.

FIG. 4 shows another embodiment of the invention. In this embodiment, valve 264 has been removed, and the back pressure controller 290 has been replaced with a manually adjustable orifice 293. Manually adjustable orifice 293 has a similar effect as that of the back pressure controller 290 with the back pressure controller having feedback control. The position of valve 264 can be downstream of the gas heater 224 as shown in FIG. 3 or upstream of the gas heater as depicted as valve 294 in FIG. 4. The pressure set point of the pressure controller is dictated by the purge gas coming from valve 281 on the purge line 280 and thru three-way valve 219. The set point pressure can be lower or higher than the purge gas depending on Venturi effect.

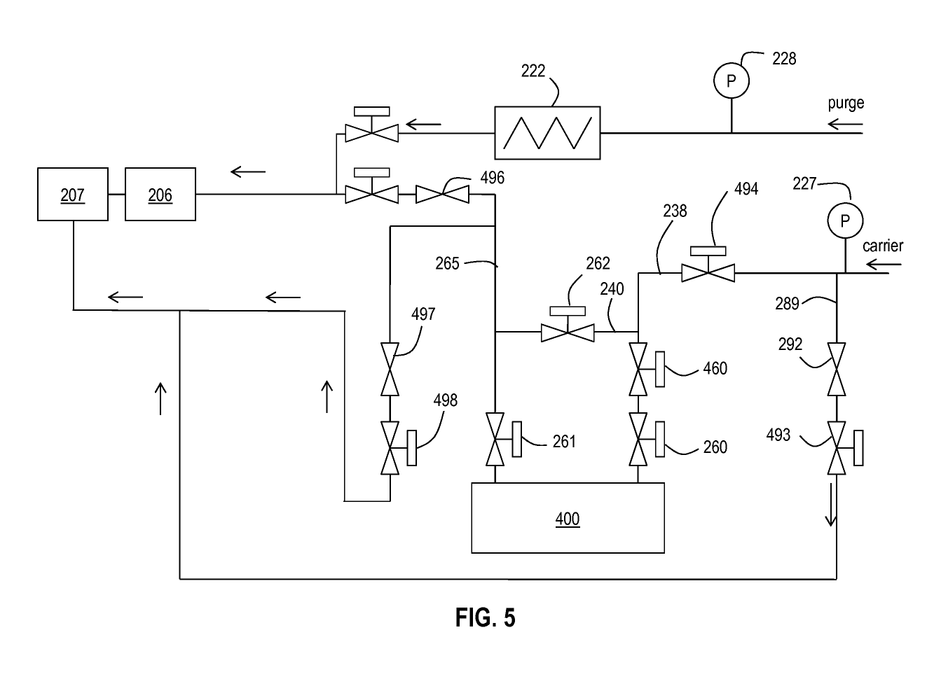

FIG. 5 shows a similar mechanism to that of FIGS. 3 and 4 but which modifications which may be useful with to a liquid vapor delivery system. In the embodiment of FIG. 5, controllers 493, 494 serves a similar function as that of valves 293, 294 of FIG. 4, where the carrier gas flow can be diverted upstream of the ampoule 400. Isolation valve 496 serves to isolate the gas flows from valve 208 prior to entering the chamber 206.

For the liquid delivery system of FIG. 5, where the vapor pressure of some precursors, such as TiCl₄, TMA, or SiCl₄, are higher, pressure stabilization downstream of the ampoule 400 may be important. Therefore, a manually adjustable orifice 460, or pressure controller, is placed directly upstream of the pulsing valve 260 and is used to maintain pressure in the ampoule 400. The adjustable orifice 460 should be in close proximity to the pulsing valve 260 to remove any dead volume between the pulsing valve 260 and the orifice 460. The setup for liquid hardware is the same as that for the solid. For the solid delivery, the pressure in the delivery line is modulated by the pressure of the purge gas. For the liquid delivery, needle valves are used to further modulate the pressure in the delivery system. Needle valve 496 controls flow to the chamber 206 and needle valve 498 control flow to the exhaust 207.

In some embodiments, referring back to FIG. 3, the ampoule 200 further includes an additional conduit 250 with an isolation valve 251. This additional conduit 250 and isolation valve 251 can be used to charge or back-fill some or all components of a precursor ampoule with an inert gas, such as He. The ampoule 200 can be charged with an inert gas at a pressure above atmospheric pressure to prevent contaminants from entering the ampoule 200. The ampoule 200 may also be enclosed in a heating mechanism (not shown) which may provide more uniform heating of its contents via one or more layers of a thermally conductive coating.

For reasons of chemical compatibility and mechanical strength, body 170 is typically made of a stainless steel, such as 316 stainless steel (316 SST). The material of body 170 should be fairly chemical inert since different types of chemical precursors, such as highly reactive materials, may be stored within body 170. Substantial mechanical strength is a desirable characteristic for body 170 of ampoule assembly 100. In some embodiments, body 170 may be operated at below atmospheric pressure during processes and may be pressurized above atmospheric pressure for transport and storage. Hence, body 170 must act as a reliable containment vessel for a toxic chemical precursor while utilized as a vacuum chamber or as a pressure vessel.

Undesirable thermal gradients may develop inside body 100 during use since 316 SST is a poor medium for thermal conductivity. For example, when a liquid chemical precursor is contained inside body 100, more volume of body 100 is vapor-filled as the liquid precursor is depleted, poor thermal conductivity of body 100 may result in uneven heating (e.g., hot spots) within the liquid precursor later in the life of the ampoule. In another example, such as when body 100 contains a solid chemical precursor, poor thermal conductivity of body 100 may create hot spots throughout the life of the ampoule. In either case, a CVD process or an ALD process may be detrimentally affected by such temperature non-uniformities.

Solid chemical precursors may be used to form process gases include tantalum precursors, such as pentakis(dimethylamido) tantalum (PDMAT; Ta(NMe₂)₅), pentakis(diethylamido) tertiaryamylimido-tris(dimethylamido) tantalum (TAIMATA, (^{t}AmyIN)Ta(NMe₂)₃, wherein ^{t}Amyl is the tertiaryamyl group (C5H₁₁ or —CH₃CH₂C(CH₃)₂—), or derivatives thereof. In one embodiment, the PDMAT has a low halogen content (e.g., CI, F, I, or Br). The PDMAT may have a halogen concentration of less than about 100 ppm. For example, the PDMAT may have a chlorine concentration of less than about 100 ppm, preferably, less than about 20 ppm, more preferably, less than about 5 ppm, and more preferably, less than about 1 ppm, such as about 100 ppb or less.

Other solid chemical precursors that may be used to form process gases through a sublimation process include hafnium tetrachloride (HfCl₄), xenon difluoride, nickel carbonyl, and tungsten hexacarbonyl, or derivatives thereof. In other embodiments, liquid chemical precursors may be evaporated to form process gases within ampoules described herein. Other chemical precursors that may be used to form process gases include tungsten precursors, such as tungsten hexafluoride (WF₆), tantalum precursors, such as tantalum (PDEAT; Ta(NEt₂)₅), pentakis(methylethylamido) tantalum (PMEAT; Ta(NMeEt)₅), tertbutylimino-tris(dimethylamino) tantalum (TBTDMT, ^{t}BuNTa(NMe₂)₃), tertbutylimino-tris(diethylamino) tantalum (TBTDET, ^{t}BuNTa(NEt₂)₃), tertbutylimino-tris(methylethylamino) tantalum (TBTMET, ^{t}BuNTa(NMeEt)₃), or derivatives thereof, titanium precursors, such as titanium tetrachloride (TiCl₄), tetrakis(dimethylamino) titanium (TDMAT, (Me₂N)₄Ti)), tetrakis(diethylamino) titanium (TEMAT, (Et₂N)₄Ti)), or derivatives thereof, ruthenium precursors, such as bis(ethylcyclopentadienyl) ruthenium ((EtCp)₂Ru), hafnium precursors, such as tetrakis(dimethylamino) hafnium (TDMAH, (Me₂N)₄Hf)), tetrakis(diethylamino) hafnium (TDEAH, (Et₂N)₄Hf)), tetrakis(methylethylamino) hafnium (TMEAH, (MeEtN)₄Hf)), or derivatives thereof, and aluminum precursors, such as 1-methylpyrolidrazine:alane (MPA, MeC₄H₃N:AlH₃), pyridine:alane (C₄H₄N:AIH₃), alkylamine:alane complexes (e.g., trimethylamine:alane (Me₃N:AlH₃), triethylamine:alane (Et₃N :AlH₃), dimethylethylamine:alane (Me₂EtN:AlH₃)), trimethylaluminum (TMA, Me₃Al), triethylaluminum (TEA, Et₃l), tributylaluminum (Bu₃Al), dimethylaluminum chloride (Me₂AlCl), diethylaluminum chloride (Et₂AlCl), dibutylaluminum hydride (Bu₂AlH), dibutylaluminum chloride (Bu₂AlCl), or derivatives thereof. In one or more embodiments, the precursor if hafnium tetrachloride.

The purge gas can be any suitable purge gas known in the art. Suitable purge gases include, but are not limited to, helium, nitrogen, neon, argon, krypton and xenon. In some embodiments, the purge gas is nitrogen.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. An apparatus for generating a chemical precursor, the apparatus comprising:
an inlet line in fluid communication with a carrier gas, the inlet line having an ampoule inlet valve to control flow of the carrier gas into an ampoule,
an outlet line having an outlet valve to control flow of precursor vapor and carrier gas exiting an ampoule;
a bypass valve downstream of the ampoule outlet valve, the bypass valve allowing the carrier gas to flow from the inlet line to purge the outlet line without flowing carrier gas into an ampoule;
a purge line comprising a second outlet valve in fluid communication with the purge line to flow a purge gas to a processing chamber; and
a third outlet valve to flow the chemical precursor from an ampoule to a foreline bypassing the processing chamber.

2. The apparatus of claim 1, wherein the bypass valve is upstream of the ampoule inlet valve.

3. The apparatus of claim 1, wherein the second outlet valve comprising a first input in fluid communication with the purge line and second input in fluid communication with the outlet line.

4. The apparatus of claim 3, wherein the second valve is a three-way valve which can pass only the flow from the outlet line or only the flow from purge line, or a mixture of flows from the purge line and the outlet line to the processing chamber.

5. The apparatus of claim 1, further comprising an ampoule having a top, bottom and a body defining an interior volume, the ampoule comprising an inlet conduit and an outlet conduit.

6. The apparatus of claim 5, wherein the ampoule further comprises at least one of additional conduit with an isolation valve, the additional conduit in fluid communication with an interior of the ampoule.

7. The apparatus of claim 5, wherein the ampoule contains a solid precursor.

8. The apparatus of claim 1, wherein the processing chamber is a chemical vapor deposition chamber or an atomic layer deposition chamber.

9. The apparatus of claim 1, wherein one or more of the inlet line and the purge line comprises a heater.

10. The apparatus of claim 9, further comprising a monometer upstream of each heater.

11. The apparatus of claim 1, wherein the inlet line comprises an exhaust line upstream of the ampoule.

12. The apparatus of claim 11, wherein the exhaust line comprises a back pressure controller upstream of and in fluid communication with an isolation valve.

13. The apparatus of claim 11, wherein the exhaust line comprises a manual orifice upstream of and in fluid communication with an isolation valve.

14. An apparatus for generating a chemical precursor, the apparatus comprising:
an inlet line comprising a first heater and a first valve, the inlet line to be connected to an inlet conduit of an ampoule;
an outlet line comprising a first three-way valve and a second three-way valve, the first three-way valve having one inlet and two outlets with one of the two outlets connecting to an exhaust and the other outlet in fluid communication with the second three-way valve, the second three-way valve having two inlets and one outlet, the first inlet in fluid communication with the outlet of the first three-way valve and the second inlet in fluid communication with a purge line, the outlet line to be connected to an outlet conduit of the ampoule upstream of the first three-way valve;
a purge line comprising a second heater and a second valve, the purge line in fluid communication with one inlet of the second three-way valve; and
a bypass line comprising a bypass valve, the bypass line in fluid communication with the inlet line downstream of the first heater and the first valve and the outlet line upstream of the first three-way valve, the bypass line allowing a flow of gas to pass from the inlet line to the outlet line without passing through the ampoule.

15. The apparatus of claim 14, wherein the first heater is upstream of and in fluid communication with the first valve or downstream of and in fluid communication with the first valve.

16. The apparatus of claim 14, wherein the second heater is upstream of and in fluid communication with the second valve.

17. The apparatus of claim 14, further comprising an exhaust line upstream of the first heater and in fluid communication with the inlet line.

18. The apparatus of claim 17, wherein the exhaust line comprises a back pressure controller upstream of and in fluid communication with an isolation valve.

19. The apparatus of claim 17, wherein the exhaust line comprises a manual orifice upstream of and in fluid communication with an isolation valve.

20. An apparatus for generating a chemical precursor, the apparatus comprising:
an inlet line comprising a first heater upstream of and in fluid communication with a first valve, the inlet line configured to be connected to an inlet conduit of an ampoule;
an outlet line comprising a first three-way valve and a second three-way valve, the first three-way valve having one inlet and two outlets with one of the two outlets connecting to an exhaust and the other outlet in fluid communication with the second three-way valve, the second three-way valve having two inlets and one outlet, the first inlet in fluid communication with the outlet of the first three-way valve and the second inlet in fluid communication with a purge line, the outlet line configured to be connected to an outlet conduit of the ampoule upstream of the first three-way valve;
a purge line comprising a second heater and a second valve, the purge line in fluid communication with one inlet of the second three-way valve; and
a bypass line comprising a bypass valve, the bypass line in fluid communication with the inlet line downstream of the first heater and the first valve and the outlet line upstream of the first three-way valve, the bypass line configured to allow a flow of gas to pass from the inlet line to the outlet line without passing through the ampoule.
